(19) United States
(12) Patent Application Publication
(10) Pub. No.: US 2002/0035500 A1
(43) Pub. Date: Mar. 21, 2002

(54) Multi-dimensional management method and system

(76) Inventors: Shinji Yoko, Tokyo (JP); Michihiro Tame, Tokyo (JP)

Correspondence Address: MORGAN, LEWIS & BOCKIUS LLP, 1800 M Street, N.W., Washington, DC, 20036, US

(21) Appl. No.: 09/871,697

(22) Filed: Jun. 4, 2001

Related U.S. Application Data
(60) Provisional application No. 60/208,922, filed on Jun. 5, 2000.

(51) Int. Cl. G06F 17/60

(52) U.S. Cl. 705/9

(57) ABSTRACT

A method and system for managing an objectives-based business plan. Major objectives are defined according to one or more parameters and are stored in a first database. Based on the major objectives, minor objectives are defined according to one or more parameters. The minor objectives are stored in a second database. Then, the major objectives and the minor objectives are managed according to the method and system of the present invention.

### RELATED APPLICATIONS

This application claims the benefit of a provisional application entitled “Multi-Dimensional Matrix Management System and Method,” which was filed on Jun. 5, 2000,and assigned Provisional Application No. 60/208,922, which is hereby incorporated by reference.

### BACKGROUND

1. Field of the Invention

The present invention relates to a multi-dimensional management method and system, and more particularly, to a management method and system for defining and managing corporate objectives. Also, the present invention relates to a multi-dimensional matrix management method and system for managing corporate objectives along to four axes for products, applications, territories and accounts.

2. Background of the Invention

Information technology enables companies to manage global operations that may include manufacturing facilities, suppliers, marketing operations, and customers located in various countries. For example, a company may develop TV sets in Eindhovem, Holland and produce them in France, Singapore, and the United States. The purchasing negotiations for components of the TV sets may be conducted in Tokyo, Japan. A supplier may have designed the transformer in Holland but produces them in Hungary, Singapore, and Mexico.

Faced with the complexities and challenges of operating in a global marketplace (i.e., across borders, across cultures, and at all times), multinational companies have devised numerous methods and systems for implementing corporate strategies and objectives. However, many current management systems have become inadequate or overburdened as developments in information technologies improve global communications.

For instance, some current management approaches and systems are inadequate because they fail to take into account the factors or parameters involved in operating worldwide. To succeed in the global marketplace, multinational companies should efficiently and globally execute a uniform strategy that transcends borders, cultures, and time-zones. Traditional management systems are often devised around or focused on only a few parameters, such as the territory 32 defining a sales region and the particular product 34 being sold. Therefore, there is a need for a multi-dimensional management system that takes additional parameters into consideration, thereby providing a horizontally and vertically integrated management method and system for creating, executing, and tracking corporate objectives in a global operating environment.

In failing to appreciate the complexities of the global marketplace, current management techniques tend to embody a hierarchical management structure, as depicted in FIG. 1. Although a pyramid-type management structure may have been adequate in a business environment involving only a domestic market, global markets demands and improved communication means have rendered the management structure virtually obsolete. Therefore, there is a need for a management system that embodies a flexible decision- making mechanism characterized by information sharing, multiple inputs, and mutuality.

The increased communication capabilities associated with recent technological advances has been both a benefit and detriment to global companies. Improved communications enables companies to devise more complex management schemes that may involve multiple parameters. However, as shown in FIG. 2, without an overall method and system for implementing a multi-dimensional business plan, communications can overburden and swamp traditional management methodologies. Therefore, there is a need for a multi-dimensional management system that can be horizontally and vertically implemented in an organization using information technology, thereby providing worldwide access to up-to-date information.

By the way, variety of business management systems, for managing by comparison sales goal values with actual performances, has been developed and practiced. Almost systems are utilized for managing achievement of sales goal values according to product, application, account or sales rep (representative). Thus, conventional management systems could only estimate or evaluate in figures such as sales volume. Recently, as globalization of the economy has been accomplished, it is often the case that customer accounts business operation are spread worldwide not only in single country. Hence, the management systems for evaluating and managing sales targets and results according to territory (for example, country or region such as Asia or Europe etc.) are developed and operated.

However the conventional business management systems could manage along only single strategy axis such as products, applications (end products), account or territories, and could not manage these axes simultaneously and flexibly within a limited amount of time. For example, if one account of a multinational corporation has some business centers in plural of countries and that account purchases a variety of products in plural of countries, the conventional management systems can not properly manage sales goals and business management in consideration of both of products and territories, or four strategic axes such as products, applications, accounts and territories. Also, the conventional management systems intended only for target of value of sales or sales figures that could be estimated or managed in figures, thus the systems could not manage action plans such as specific operating activities. For example, it is extremely important that, in the business operation about selling electric components, each of selling stages, such as ‘meeting with engineers’, ‘shipping a first prototype’, ‘feedback of evaluation of a first prototype’, shipping a second prototype’, ‘feedback of evaluation of a second prototype’, ‘meeting with purchasing clerk’, ‘purchase decision-making’, ‘purchase price decision-making’, ‘contract’ and ‘shipping’, are appropriately managed. However, the conventional systems could not manage simultaneously and flexibly both of action plans and sales targets. In addition, the conventional systems could not manage simultaneously and flexibly action plans, sales goals and its sales results.

In the conventional systems, due to a fact that a manager could determine sales activity policy based on the aggregation figures and that a sales rep could perform sales activities attaining sales goals decided by a manager and input sales actual results, the manager or the sales rep could not comprehend progress status or situation of sales activities of individual sales rep which could not be expressed as sales results, and could not manage based on such progress status. Thus, it is required to develop a communication system, in which a sales rep can input progress status of individual sales activities and assist or support request and a manager can feedback his or her comments in response to the support request of said sales rep.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a typical hierarchal leadership structure;

FIG. 2 depicts the complexity of a multi-dimensional management method and system;

FIG. 3 conceptually illustrates the relationship between the market and employees of an organization implementing one embodiment of the present invention;

FIG. 4 illustrates a multi-dependent management structure;

FIG. 5 is a flow diagram showing an overall method for practicing one embodiment of the present invention;

FIG. 6 is a flow diagram showing a process for defining the major objectives according to one embodiment of the present invention;

FIG. 7 is a flow diagram showing a process for defining the minor objectives according to one embodiment of the present invention;

FIG. 8 is a schematic showing the relationship between the methodological and system components according to one embodiment of the present invention;

FIG. 9 shows a screen shot listing exemplary major objectives according to one embodiment of the present invention;

FIG. 10 shows a screen shot displaying a sample major objective and its components;

FIG. 11 shows a screen shot displaying the contents of an exemplary minor objective based on four parameters;

FIG. 12 shows a screen shot displaying an exemplary schedule for achieving a minor objective according to one embodiment of the present invention;

FIG. 13 shows a screen shot displaying target figures of an exemplary minor objective according to one embodiment of the present invention;

FIG. 14 shows a flow diagram of an objectives-based management system according to one embodiment of the present invention;

FIG. 15 is a block diagram illustrating the basic arrangement of a computer system allows to operate the multi-dimensional matrix management system according to the invention;

FIG. 16 is a block diagram depicting a basic configuration of the multi-dimensional matrix management system of the invention;

FIG. 17 is a screen interface for displaying summary of the particular account;

FIG. 18 is a screen interface for displaying the target and actual performance in the form of a table as a format defined action plans in regards to the certain critical target (i.e. tactics and its deadlines (due date)) and for managing them; and

FIG. 19 is a screen interface for displaying and managing the monthly progress management comments by a matrix manager.

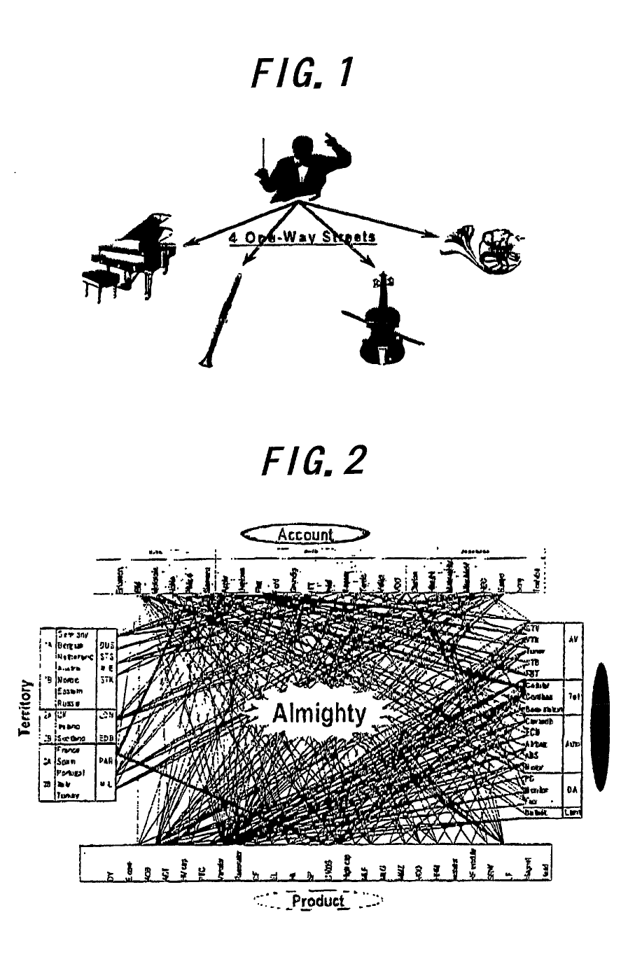

### SUMMARY OF THE INVENTION

Accordingly, the present invention is directed to a multi-dimensional management method and system that substantially obviates one or more of the problems due to limitations and disadvantages of the related art.

One object of the present invention is to provide a multi-dimensional management method and system for setting corporate objectives according to multiple parameters.

Another object of the present invention is to provide a multi-dimensional management method and system that takes into consideration the parameters product, territory, application (finished product), and account (customer account).

A further object of the present invention is to provide a method and system for uniformly implementing an objectives-based business plan in a global marketplace.

Yet another object of the present invention is to provide a computer-based method and system for globally implementing and managing corporate objectives.

Yet another object of the present invention is to provide a method and system for efficiently utilizing information technology resources to implement an objectives-based business plan.

Yet another object of the present invention is to provide a method and system for efficiently managing and tracking corporate objectives.

Yet another object of the present invention is to provide a method and system for simultaneously managing corporate objectives based on product, territory, application, and account, regardless of time and geography.

Yet another objective of the present invention is to provide a method and system for managing sales growth in view of the corporate objectives and strategies.

Yet another objective of the present invention is to provide a method and system for tracking and measuring each employee's progress in accomplishing the objectives, thereby enabling the fair and efficient evaluation of each employee's performance.

Yet another objective of the present invention to provide an improved business management system for managing simultaneously and flexibly both of an action plan and an sales target.

Additional objects and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, in one aspect of the present invention there is provided a method for managing an objectives-based business plan that includes the steps of defining major objectives according to one or more parameters; storing said major objectives in a first database; defining minor objectives based on the major objectives, wherein said minor objectives are defined according to one or more parameters; storing said minor objectives in a second database; and managing said major objectives and said minor objectives.

In another aspect, the present invention provides a method for managing an objectives-based business plan that includes the steps of defining major objectives according to one or more parameters; defining minor objectives based on the major objectives, wherein said minor objectives are defined according to one or more parameters; implementing said major objectives and said minor objectives, wherein each major objective is implemented by at least one manager and wherein said related minor objectives are implemented by at least one member of the at least one manager's team; managing said major objectives and said minor objectives; and evaluating the at least one manager's performance in achieving said major objectives and evaluating the team member's performance in achieving the related minor objectives.

In another aspect of the present invention there is provided a system for managing an objectives-based business plan that includes a first database for storing major objectives based on one or more parameters; a second database for storing minor objectives based on the major objectives, wherein said minor objectives are defined according to one or more parameters; and an information processing component for manipulating content of said first database and said second database.

According to the another aspect of the invention, a system for managing corporate objectives in multi-dimensional matrix, the system comprises:

means for storing a initial target including at least sales goals and action plans in a database in the form of multi-dimensional matrix consisting of four axes i.e. products, territories, applications and accounts;

means for prompting to input a actual performance including actual money of sales performance or actual volume of sales performance and actual sales activities corresponding to said initial target till predetermined due date using a local and/or remote terminal;

means for receiving said actual performance via network;

means for storing said received actual performance in the database;

means for managing a target achievement by reading the said initial target and said actual performance and selecting any one or more from said four axes and displaying said initial target and/or said actual performance along to the selected axis or axes on the local and/or remote terminal.

According to this arrangement, the sales goals that is business properly may be managed in view of four strategic axes such as products, territories, applications and accounts. For instance, if it is desired to analyze an actual situation with an emphasis on territories, sales status of each territory may be managed by selecting territories as an axis. Also, if other axis such as products is selected, likewise sales status of each product may be managed. As well, one or more axes can be selected, for example if territories and products are selected as a first and a second axis, respectively, roughly sales status is displayed in the form of segmented by each territory, and for details sales status of each product in the each territory is easily and simply comprehended, a manager or a sales rep can properly manage the business.

In a preferable embodiment of the system according to the invention, the system for managing corporate objectives in multi-dimensional matrix comprises:

means for managing a sales achievement by comparing said initial target with said actual performance corresponding to said initial target and based on this comparison sorting said initial target and/or said actual performance and displaying them on the local or remote terminal.

According to this arrangement, for example, because of the comparison results can be sorted by predetermined some thresholds which have some steps (for example, 100% achievement, 80% achievement and 50% achievement etc.), business results may easily be comprehended according to each axis. For example, accounts can be displayed in the order in which sales results of accounts are good in some territories, or in the order in which sales results of some products are good. These display operation can easily and simply be performed.

According to the invention, it is preferable that the system comprises:

said means for managing a sales achievement further comprises;

means for changing a display style said initial target and/or said actual performance based on said comparison and displaying them on the local or remote terminal.

According to this arrangement, sales results can easily be comprehended by displaying the sales results based upon the said comparison in the form of the letter or background, for example, sales results of actual performance of 100% achievement is in blue, that of 80% achievement is in yellow and that of 50% achievement is in red.

According to the invention, it is preferable that the system is characterized in that:

said actual performance further comprises progress codes, expressing progress status, including at least ‘on the schedule’, ‘behind the schedule’ and ‘completed’, the system comprises:

means for managing progress by displaying the said actual performance based on the said progress code and/or any one of said four axes on the local and/or remote terminal.

According to this arrangement, progress condition of each axis can easily be comprehended, thus business decision may be timely and properly performed.

According to the invention, it is preferable that the system comprises:

means for altering said initial target based on said actual performance or business trend.

According to this arrangement, in order to approach target values more properly, the initial target may be altered or modified based on the progress codes, actual performance such as actual status of sales activities or up-to-date information of various economic conditions (such as GNP growth rate, inflation rate or exchange), thus business decision can speedy and properly be performed.

According to the invention, it is preferable that the system comprises:

means for altering said initial target based on said actual performance or business trend.

According to this arrangement, by communicating two-way communication forcibly between each rep and manager, problem can properly and efficiently be addressed.

According to the invention, it is preferable that a method comprises the steps of:

storing a initial target including at least a sales goal and an action plan in a database in the form of multi-dimensional matrix consisting of four axes of a product, a territory, an application and an account;

prompting to input a actual performance including actual money or volume of sales performance and actual sales activities corresponding to said initial target for a predetermined term till predetermined due date by using a local and/or remote terminal;

receiving said actual performance;

storing said received actual performance in the database;

managing an achievement of the target by reading the said initial target and said actual performance and selecting any one or more from said four axes and displaying said initial target and/or said actual performance along to the selected axis or axes on the local and/or remote terminal.

It is to be understood that both the foregoing general description and the following detailed description are exemplary and explanatory and are intended to provide further explanation of the invention as claimed. By way of easily explanation the aspect of the present invention has been described mainly as systems i.e. devices, however it is understood that the scope of the present invention comprises methods corresponding to the system, programs embodying the methods, storage media storing the programs and equivalent these things etc.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like elements.

The present invention provides a method and system for setting and executing corporate strategies and objectives based on one or more parameters. The system involves setting major corporate objectives for each manager based on predetermined parameters, defining minor objectives for the manager's team that aid in achieving a major objective, and then utilizing technological resources to manage and track the execution of the objectives. By devising and implementing corporate objectives based on multiple parameters, the management system of the present invention enables companies to operate in a global marketplace complicated by time, geographical, and cultural constraints. As one skilled in the art will appreciate, the type and number of parameters can vary depending on the particular needs of a company.

Traditional management systems often emphasized the two parameters product and territory. One embodiment of the present invention involves setting objectives based on the four parameters of product, territory, application (finished product), and account (customer account). By contemplating additional parameters or inputs, the system of the present invention enables companies to manage their operations in a manner this is more responsive to the global business environment. Therefore, corporate objectives set in view of the four parameters provide members of an organization with a uniform method and strategy for overcoming obstacles inherent in conducting operations worldwide.

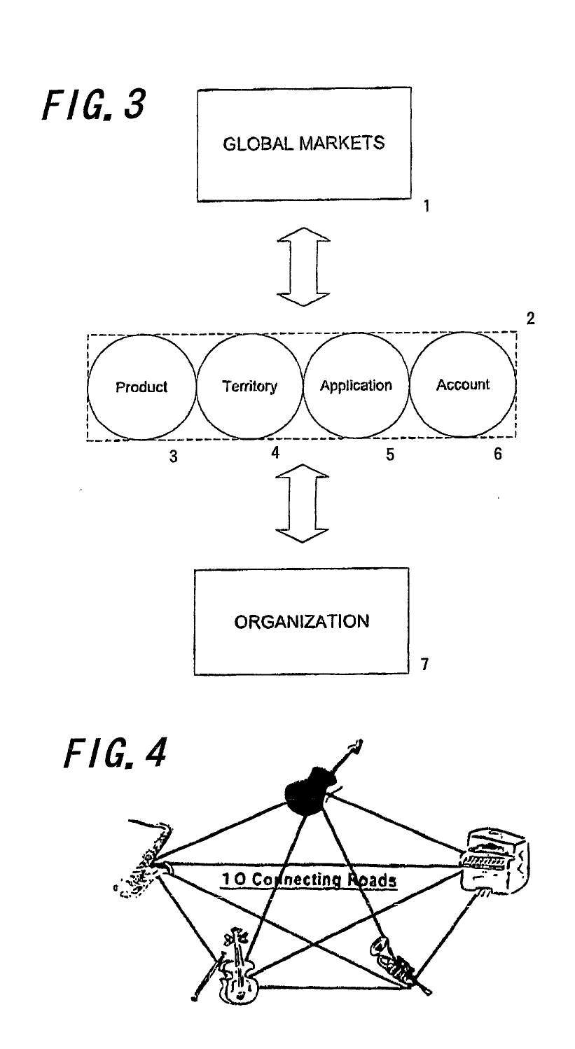

FIG. 3 conceptually illustrates the fundamental relationship between the market 1 and an organization 7 implementing one embodiment of the present invention. The parameters 2, which are product 3, territory 4, application 5, and account 6 indirectly provide relevant and timely information regarding the marketplace. Focusing the complexities of the global business environment into four parameters 2 provides a manageable context in which a company can efficiently organize it's operations and thereby provide a quality service or product to a particular market.

The horizontally and vertically integrated management system is preferably implemented using information technology to manage and track the objectives. A computer-based management system provides an efficient means for managing the tasks associated with achieving each objective. Furthermore, the computer-based system of the present invention enables managers, staff, and others to access information regarding the status of individual or aggregated objectives according to four parameters preselected by the organization.

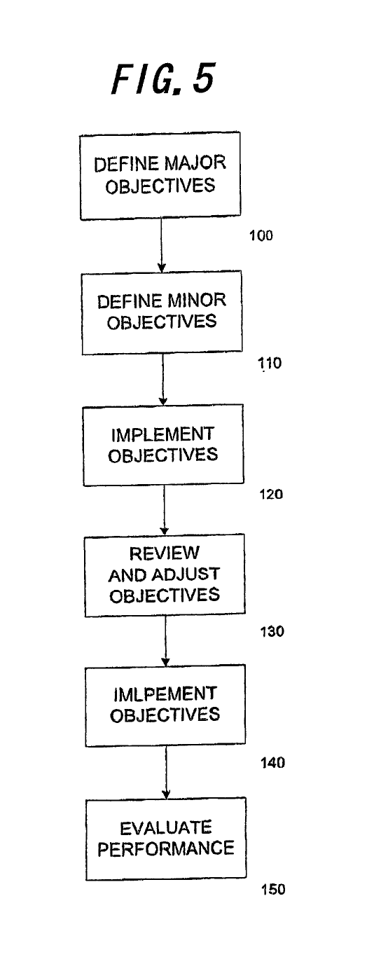

Because of the information and communication needs of each employee acting according to the management system, the present invention contemplates a flexible management structure that is characterized by multiple inputs, mutuality, and information sharing, as shown in FIG. 4.

The information sharing and input requirements of a multi- dimensional management system designed around the four parameters previously mentioned would overwhelm a traditional hierarchical management structure. For example, a design facility located in Chile that needs certain marketing information regarding a product to be manufactured in Korea and sold in Japan can communicate directly with pertinent parties, rather than overwhelming a single point of contact with numerous requests for information.

The overall method of the present invention is best understood by reference to the flow diagram shown in FIG. 5. Each of the following process steps will be discussed in greater detail below. Preferably at the beginning of the calendar or fiscal year the managers of a company at step 100 define the major objectives according to particular parameters (e.g., product, account) 2. The managers may consider inputs from various sources. The major objectives preferably provide a measurable goal and an action plan to achieve that goal. In view of each major objective, at step 110 minor objectives are determined by consensus for the manager's team. Typically, each member of a manager's team will be responsible for approximately 15 minor objectives that are in tune with one or more of the major objectives assigned to the employee's manager.

After the minor objectives are determined according to a consensus-oriented approach involving the managers and staff, at step 120 all participating members strive to implement the objectives according to defined schedules or procedures. Because of possible changes in the business environment, at step 130 the minor objectives are reviewed and adjusted after a fixed amount of time. Then at step 140, the participating members of the company implement the original or adjusted objectives for the remainder of the calendar or fiscal year. To measure progress in achieving each objective, the managers preferably report monthly on the status of their major objectives. Furthermore, each team member may also provide timely updates for each minor objective, thereby enabling the measurement and tracking of both the minor and major objectives. Finally, at the end of the year each team member's performance is evaluated at step 150. Therefore, the employee's compensation can be accordingly adjusted.

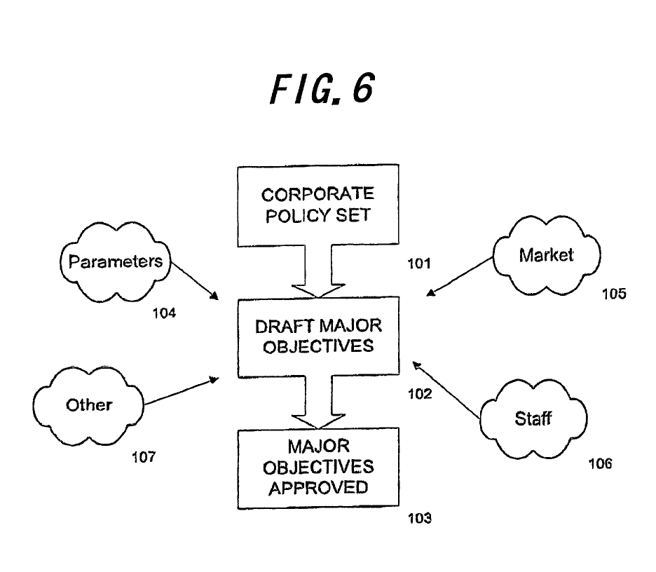

Each step shown in FIG. 5 will be presented in more detail. FIG. 6 shows a flow diagram of one embodiment of the present invention for defining the major objectives 100. As shown in FIG. 6 at step 101, the General Manager or any another corporate body announces the goals and strategy of the company for the upcoming year. In view of the announced corporate goals 101, the four parameters 2 (of FIG. 3), and inputs from the market 105, staff 106, and other sources 107, the designated managers propose major objectives related to the four parameters at step 102. The major objectives preferably cover all relevant areas, such as sales, marketing, engineering, financial performance, administration, and human resources.

When defining major objectives in tune with the corporate goals, the managers must also consider other factors 107 including, but not limited to, administrative, financial, technological, and legal factors. Preferably, each major objective includes a clear and measurable goal and a monthly schedule, plan, tactic, or procedure for achieving the goal. Then at step 103, senior management approves the major objectives. Otherwise, the managers would have to revise their major objectives to gain senior management approval. Preferably, each manager is assigned at least one major objective for each parameter in which the manager is responsible.

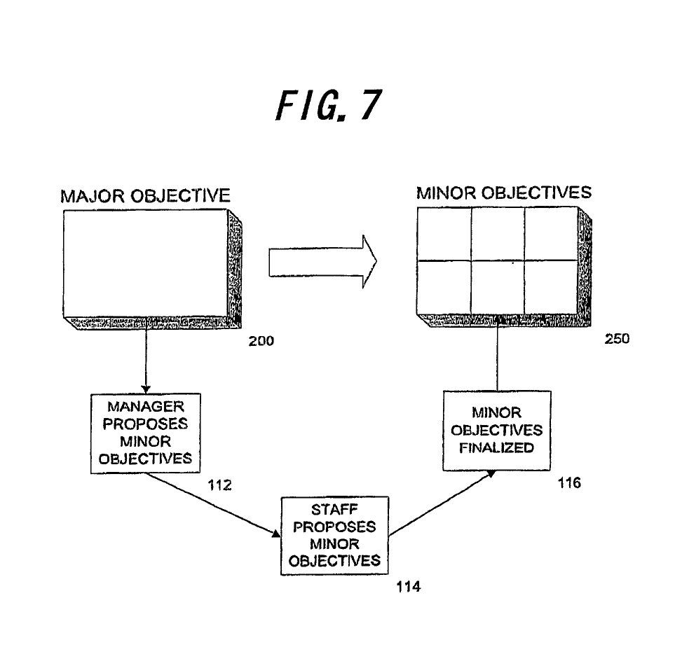

After the major objectives have been defined at step 100 of FIG. 5, then the minor objectives for each member of the manager's team are determined at step 110. The flow diagram in FIG. 7 shows this process in more detail. After the major objectives 200 related to certain parameters have been defined for a particular manager, minor objectives 250 are determined for each member of the manager's team. Preferably, each minor objective 250 is defined in view of one or more major objectives 200, thereby contributing to the achievement of the major objectives 200. For example, the one major objective 200 shown in FIG. 7 has been schematically broken down into six (6) exemplary minor objectives 250.

One embodiment of the method for determining the minor objectives 250 for each employee is shown in steps 112 through 116 of FIG. 7. Preferably, the minor objectives 250 are determined through a consensus process involving senior management, the managers, and the team members (i.e., staff). Initially, each manager proposes clear and achievable objectives at step 112 for each member of the manager's team. At step 114, the staff may also propose objectives in view of their customer and market experience. Then preferably during an off-site meeting, all participants discuss, counter-propose, and finally agree by consensus at step 116 on the minor objectives 250 for the following year.

Referring to FIG. 5, the employees at step 120 then implement the minor objectives 250. A computer-based system for measuring and tracking progress in achieving individual minor objectives 250 and in achieving the major objectives 200 will be discussed in greater detail below. Preferably, after six (6) months the minor objectives 250 are reviewed and adjusted at step 130 according to market conditions and revised expectations. After another period of execution at step 140 according to the defined schedules and procedures, the period for execution is terminated and each employee is evaluated at step 150.

The present embodiment is preferably conducted over approximately eighteen (18) months. Approximately three (3) months are allocated for the steps of defining the major objectives 200 and minor objectives 250. The company then implements the finalized plans for approximately twelve (12) months, which includes the step of reviewing the minor objectives at step 130. Finally, the results for the past year are analyzed and evaluations are conducted within roughly three (3) months. One skilled in the art will appreciate that the present invention can be utilized within any time frame determined by the company. Therefore, a company utilizing the method and system of the present invention could define a total time frame shorter or longer than eighteen (18) months. Moreover, the time for executing each step of the process could also be adjusted according to the operating needs of a company.

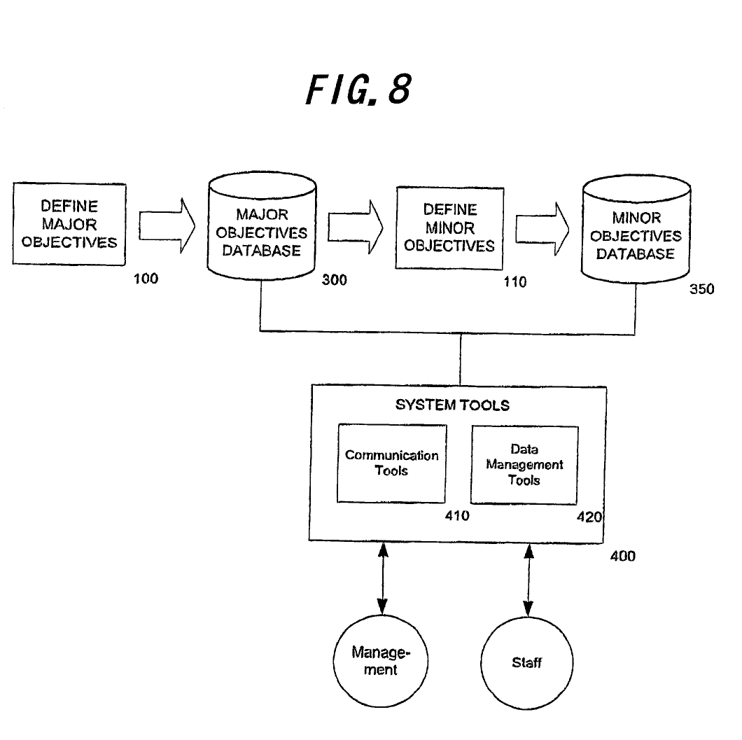

To implement the multi-dimensional management system worldwide, on embodiment of the present invention shown in FIG. 8 contemplates a major objectives database 300, a minor objectives database 350, and one or more system tools 400 for inputting, measuring, and tracking data. FIG. 8 shows the relationships between the steps of defining the objectives and the technological aspect of the present invention. Namely, after the step of defining the major objectives 100, as previously discussed, the major objectives 200 are preferably stored in major objectives database 300. In view of the major objectives 200, the minor objectives 250 are defined at 110 and stored in a minor objectives database 350. Data from each of the databases can then be accessed and manipulated using one or more system tools 400, thereby enabling managers and staff to measure and track their assigned objectives according to the predetermined parameters.

As depicted in FIG. 8, the system tools of the present embodiment includes communication tools 410 and data management tools 420. While the communication tools 410 facilitate communication about the objectives among the geographical dispersed members of a company, the data management tools 420 facilitate the management and tracking of the objectives. Specifically, the data management tools 420 are designed to manipulate the data of the major objectives database 300 and the minor objectives database 350 according to the predetermined parameters 2. For example, a data management tool 420 may sort some or all minor objectives 250 according to the territory 24 in which the product is sold. As one skilled in the art will appreciate, access to each of the system tools 400 may vary depending on the user (e.g., senior manager, manager, staff). The major objectives database 300, the minor objectives database 350, and system tools 400 will be separately presented.

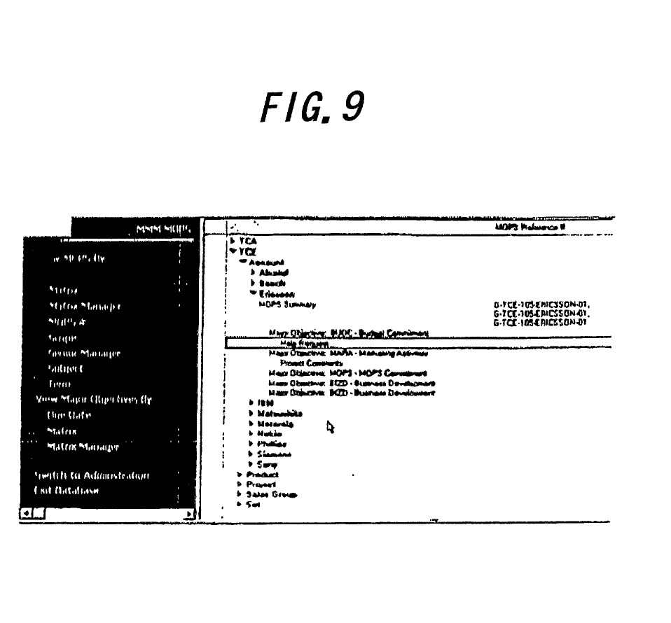

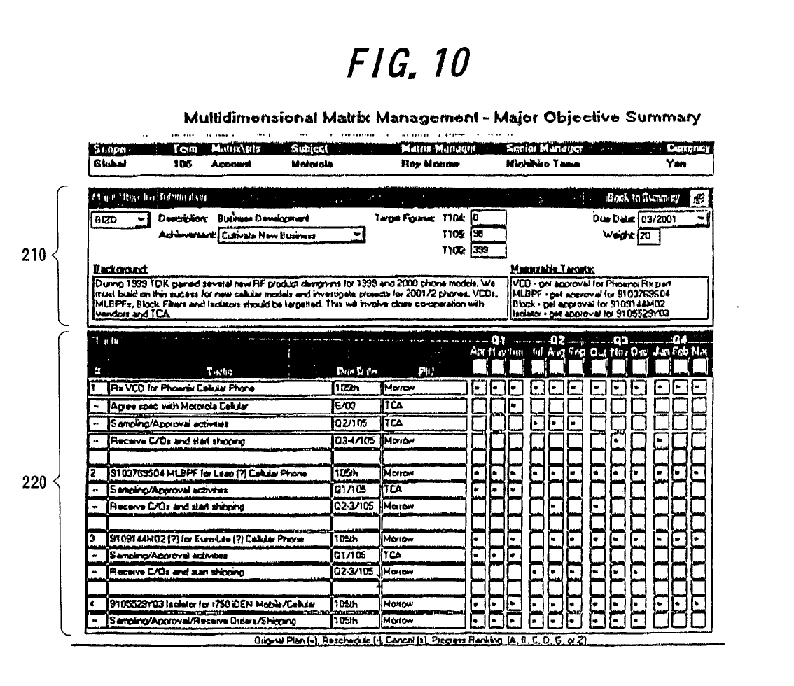

Each major objective 200, which may be defined by any number of corporate procedures, is preferably recorded in a major objectives database 300. As discussed earlier, each major objective 200 includes a measurable goal and a schedule or tactic for achieving the stated goal. FIG. 9 shows an exemplary listing of major objectives 200 defined according to one of the parameters 2. FIG. 10 shows an exemplary major objective 200 according to the account 26 parameter 2 that includes both a goal 210 and a schedule or tactic 220 for achieving the goal 210.

Referring to FIG. 8, based on the major objectives 200 recorded in the major objectives database 300, minor objectives 250 are defined at step 110, as discussed above, and stored in a minor objectives database 350. Preferably, each team member has 15 or fewer minor objectives 250 that are recorded and tracked. Since the minor objectives 250 are defined according to pre-determined parameters 2, each team member can utilize the minor objectives database 350 to track and report on minor objectives 250 that fall into their area of responsibility.

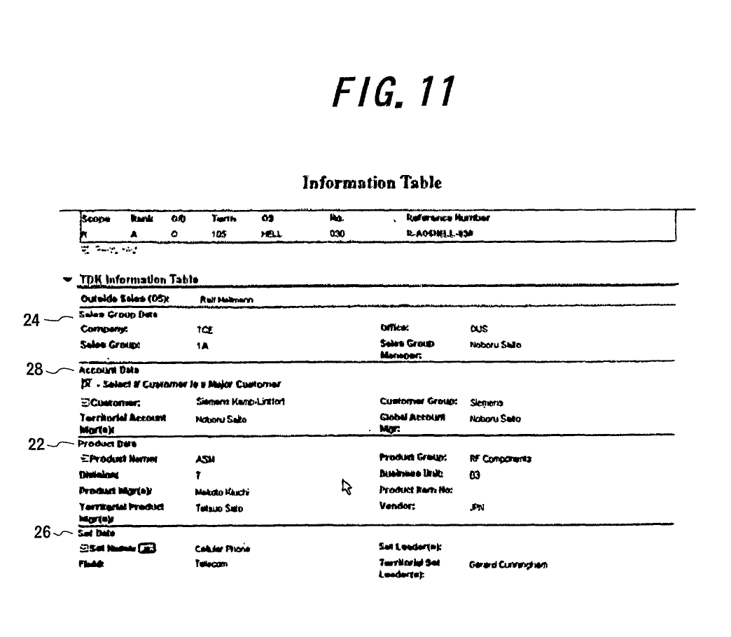

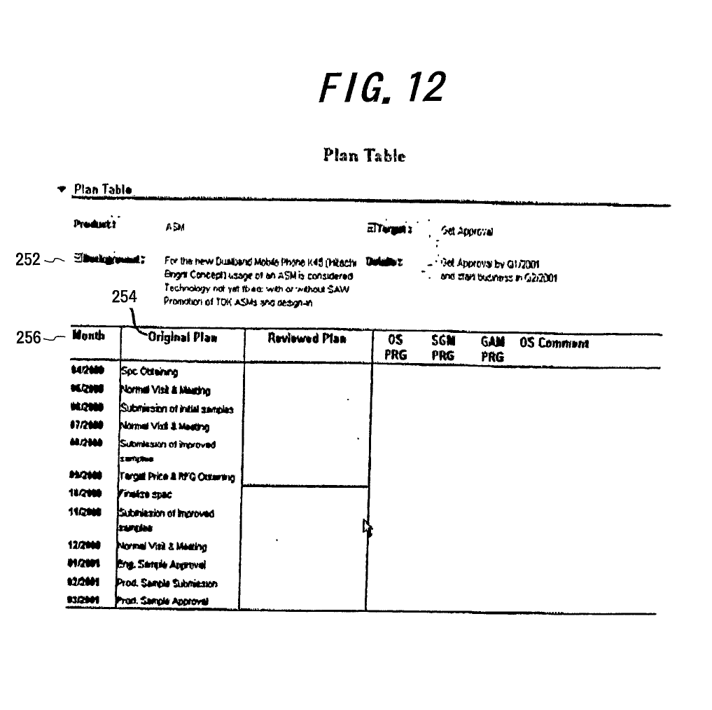

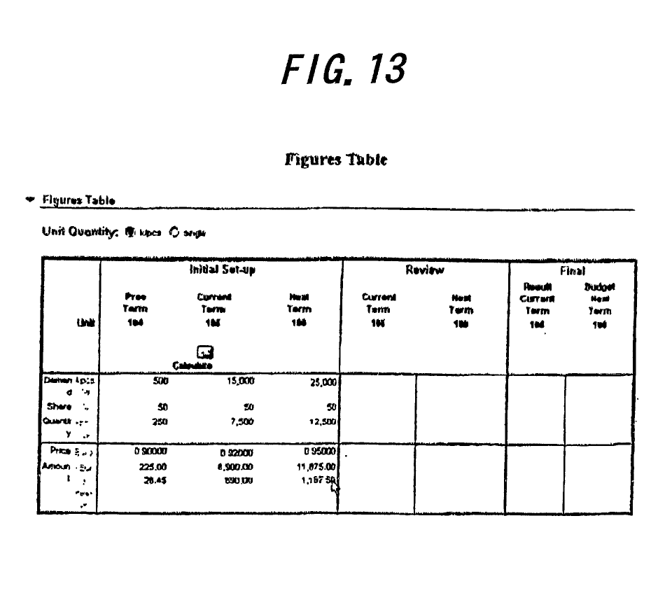

As one skilled in the art will appreciate, relevant data in the minor objectives database 350 may be stored and displayed according to any number of methods and systems. Depending on the particular industry and the needs of the company, the minor objectives 250 may be structured in a number of different manners. For instance, the minor objectives 250 can be divided into three different parts. First, the minor objectives 250 may be categorized according to the defining parameters 2 predetermined by the company. For instance, FIG. 11 shows minor objectives 250 categorized according to the four parameters: Product 3, territory 4, application 5, and account 6. As shown in FIG. 12, a background 252, plan 254, and a detailed schedule 256 may constitute a second part of a minor objective 250. Finally, as shown in FIG. 13, the minor objective 250 may include target figures, thereby enabling the team member's progress to be objectively measured.

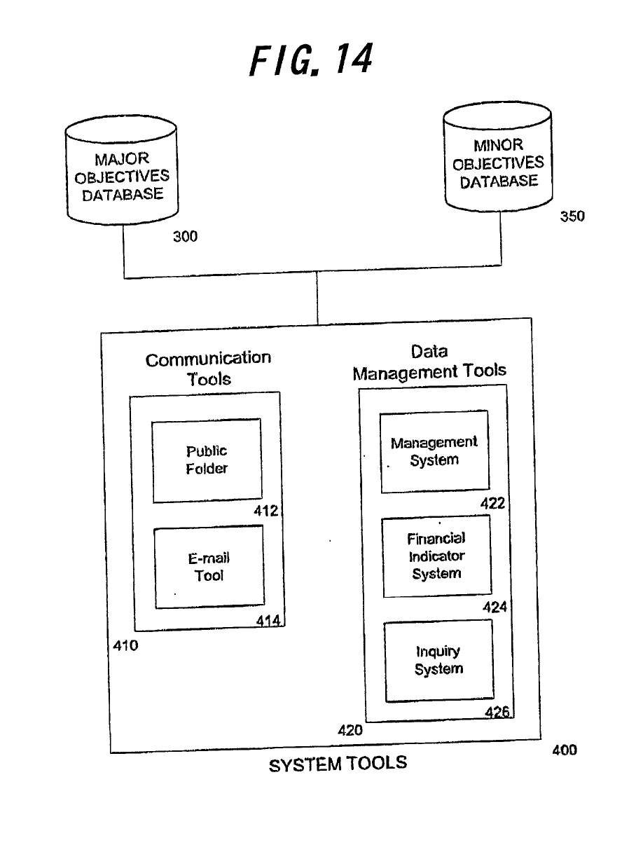

As shown in FIG. 14, the content of the major objectives database 300 and minor objectives database 350 is preferably managed and tracked using system tools 400. The system tools 400 may include communication tools 410 that facilitate the sharing of information among the geographical disperse members of a global company. In one embodiment of the present invention, the communication tools 410 include a public folder 412 and an integrated e-mail tool 414.

In the present embodiment, the public folder 412 electronically manages and stores common documents and data in one or more separate databases (not shown), thereby avoiding replication of the same document across multiple databases. The integrated e-mail tool 414 enables members of the company to comment or request help regarding a specific objective. The message is automatically sent via e-mail to the person(s) associated with the objective. Each message is stored as an attachment in the corresponding major objectives database 300 or minor objectives database 350.

The system tools 400 shown in FIG. 14 may also include one or more data management tools 420 for manipulating, displaying, and tracking data. The present embodiment contemplates three data management tools 420. A management system 422 for tracking the status of various administrative functions including, but not limited to, billing, booking, inventory, and accounting. The management system 422 can preferably sort according to one of the predetermined parameters. A financial indicator system 424 tracks the status of various sales performance indicators. Finally, an inquiry system 426 tracks the status of orders. However, one skilled in the art will appreciate that various methods and systems could be designed to manipulate, display, and track the objectives and data and stored in the major objectives database 300 and minor objectives database 350.

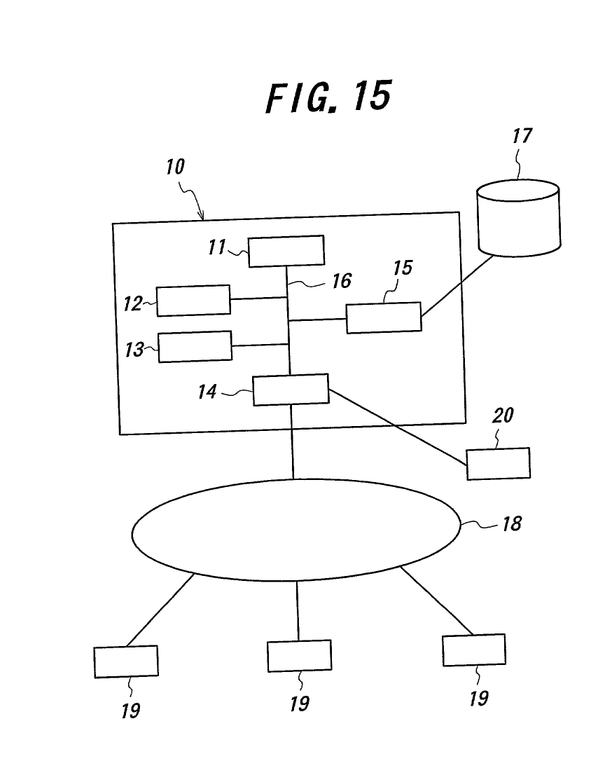

As illustrated in the FIG. 15, a computer system 10 comprises a processor 11, a RAM 12, a ROM 13, an external interface 14, an auxiliary storage controller 15 and a system bus 16. The each of elements such as RAM 12 in the computer system 10 are connected via system bus 16 to each other. The computer system 10 is connected via the auxiliary storage controller 15 to an auxiliary storage 17. A program implementing the multi-dimensional management system of the invention is stored in the auxiliary storage 17 or ROM 13. Before to operate, the program is loaded into the RAM 12, then the program are executed in the processor 11. The computer 10 is connected via the external interface 14 to network 18 such as internet and likewise is connected to a remote terminal 19 connected with the network 18. The computer 10 is connected via the external interface 14 to a local terminal 20.

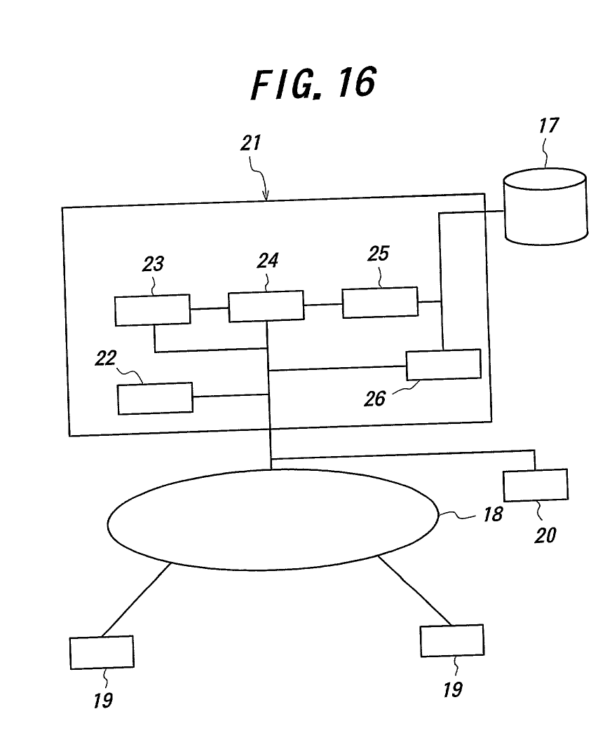

FIG. 16 is a block diagram illustrating a basic configuration of the multi-dimensional matrix management system of the invention.

As shown in the FIG. 2, the multi-dimensional matrix management system 21 comprises a means 22 for storing an initial target, a means 23 for prompting to input a actual performance, a means 24 for receiving the actual performance, a means 25 for storing the actual performance, a means 26 for managing a target achievement. The each of means is provided by the program implementing the present invention loaded into the RAM 12.

The means 22 for storing an initial target has a function for storing the initial target in a database, in the form of a multi-dimensional format of 4 axes i.e. products, territories, applications and accounts, comprising at least a sales goal and an action plan.

The means 23 for prompting to input an actual performance has function to prompting to input a actual performance including actual money or volume of sales performance and actual sales activities corresponding to said initial target in a predetermined period by using a local or remote terminal.

The means 24 has a function for receiving said actual performance.

The means 25 has a function for storing said received actual performance in the database.

The means 26 has a function for managing a target achievement by reading the said initial target and said actual performance and selecting any one or more from said four axes and displaying said initial target and/or said actual performance along to the selected axis or axes on the local or remote terminal.

The four axes of the multi-dimensional matrix management system of the invention mean products, territories, applications and accounts. It is important in the business that a target of four axes associated with each other is decided simultaneously and sales activities are performed based on one unified tactics in order to achieve the target. It is important about the target that four axes are managed simultaneously, the information is dealt beyond the deference of time and a distances on time or real time by using information technology, the target is decided beyond the deference of countries, languages, cultures, currencies and races and the target is carried out beyond the various obstructions.

Hereinafter, a process utilizing the multi-dimensional matrix management system will be specifically described.

First, the initial target is set by a manager responsible to each of axes (i.e. a target of a manager or others (for example, sales amount of money or quantity) strategy (for example, a action plan) according to the four axes, the initial target is inputted and stored using the means 21 for storing the initial target in the multi-dimensional management system 20. The target and the strategy are decided based on the data of the past (such as sales result of previous period), economic conditions, policies of the headquarters, business conditions and financial standing by the manager. The bare bones of the arranged target is sales target value (such as quantity or amount of money) that could be evaluated in figures and the bare bones of the decided strategy is, for example, specific and definite action plan for achieving the target. Generally, in order to decide the target and the strategy, the manager has a session with sales reps, staffs and executives and then decided a final target and a final strategy. Thus, it is important that whom it may be concern with business decides a target value that is clear and achievable.

For example, the amount of money of sales goals is set 9.8 billion yen in Europe area and 11.0 billion yen in worldwide. For further details, the target is set along four axes i.e. products (such as a condenser), territories (such as Asian region), applications (such as TV sets or Video recorders) and accounts (such as XXX or YYY corporation, ZZZ enterprise group). For instance, in terms of products condenser A, territories Asian area and account: A corporation, the target about XXX corporation for current term is determined as amount of sales is 100 thousand pieces, amount of money of sales is 0.2 billion yen. All of the four axes are preferably set, however it is not necessarily that all of the four axes have to be set. For example, if one of the axes (e.g. an application) is not entered and the condenser A is can be used in Video, a target for this condenser A may be automatically counted in video application by reading an another database that is descriptive of which component is applicable which application. For setting the Action plan, specific activities and its schedules are inputted, for example, as such ‘meeting with engineers by January 1’, ‘shipping a first sample by February 1’, ‘feedback of evaluation with the first sample by March 1’, shipping a second sample by April 1’, ‘feedback of evaluation of a second sample by May 1’ and ‘contract by Jun 1’ and ‘shipping by Jury 1’ in regard to product A to application C for B corporation in Asian area.

Then, when the system according to the invention is accessed by each sales rep via one of the remote or local terminals, the means 23 for prompting to input a actual performance according to the system prompt the sales rep accessed to input the actual performance (including actual amount of money or quantity of sales and actual sales activities) which corresponds to the initial target as above according to the predetermined period (e.g. daily, weekly or monthly). The prompted sales rep inputs the actual performance using the remote or local terminal. The inputted actual performance is received via network by the means 24 for receiving the actual performance. Next, The received actual performance is stored in a database built on the auxiliary storage such as a hard disc.

In practice, the target, for example, is inputted by sales rep as ‘product: condenser A, sales location: Hong kong, account: A corporation, quantity: 10 thousands, value of sales: 1 million yen’. Also, the actual sales activity (i.e. progress status) is inputted in comments field such as ‘a sample of product A is shipped. The price of Product B is presented’ by sales rep. After persons concerned references the comments field, they may input additionally comments, such as properly countermeasure or advice, in the comments field. Additionally, for example, if the actual performance including ‘sales location: Hong Kong’ is inputted, a information such as ‘territory: Asian area’ may be automatically added into the performance and the performance (including area information) may be stored in the database by referencing another database that is descriptive of which sales location is applicable which territory. In regards to another data of the performance, same technique can be used to store in the form of format reorganized in the database.

Some information of ranks expressing priority or severity may be added into the each of the targets. For instance, some information such as ‘rank A: matter of highest importance, rank B: important matter, rank C: target without numerical target (i.e. plan have no directory relevance to business growing)’ can be added into the target.

Then, when sales reps or managers select desired axis or axes using remote or local terminal, the initial target and the actual performance may be searched and read from the database and the initial target and actual performance can be displayed in the form according to the axis or axes selected by means 26 for managing the target achievement. For instance, if axis is selected as territory, they are displayed in the form of as following table 1.

TABLE 1

| | | Sales | Sales | | |
|---|---|---|---|---|---|
| | | result in | result in | | |
| | Value of | previous | current | Achievement | Growing |
| | target | term | term | ratio (%) | rate (%) |
| Area A | 1000 | 800 | 800 | 80 | 0 |
| Area B | 2000 | 1000 | 1000 | 50 | 0 |
| Area C | 4000 | 2000 | 3000 | 75 | 50 |

(Unit: billion yen)

For instance, if territory is selected as a first axis and in addition account is selected as a second axis, the initial target and the actual performance may be displayed in the from of following table 2.

TABLE 2

| | | Sales | Sales | |
|---|---|---|---|---|
| | | result in | result in | |
| | Value of | previous | current | Achievement |
| | target | term | term | ratio (%) |
| Area A | | | | |
| AA corporation | 50 | 50 | 50 | 100 |
| BB corporation | 40 | 15 | 20 | 50 |
| Area B | | | | |
| YY corporation | 30 | 10 | 10 | 33 |
| Area B | | | | |
| XX corporation | . . | . . | . . | . . |
| YY corporation | . . | . . | . . | . . |
| ZZ corporation | . . | . . | . . | . . |

As illustrated in above table 2, the initial target and the actual performance can be sorted by key of the achievement ratio, thus differences between a account of good result of sales and a account of bad result of sales may easily be recognized, so managers or sales reps may easily recognize problems. The axis can arbitrarily be selected and as mentioned above one or more axes can be selected from the four axes. Also, in regards to desired any item other than the achievement ratio, they can be sorted by key of predetermined order (ascending or descending order).

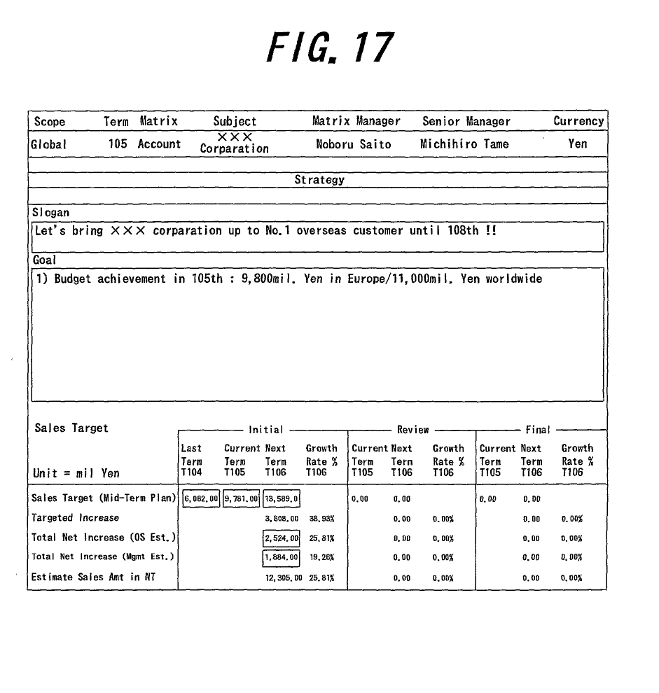

Alternatively, if the account is selected as the axis, a screen interface, which displays summary of the particular account as shown in FIG. 17, can be provided. As shown in FIG. 17, adjusted target value in addition to the initial target may be set in the ‘correction field’ in consideration of the actual performance, society status or economic conditions after lapse of predetermined period. At the end of the term, the sales result (the sales result in the current term and sales target in the next term) may be inputted in the ‘final field’.

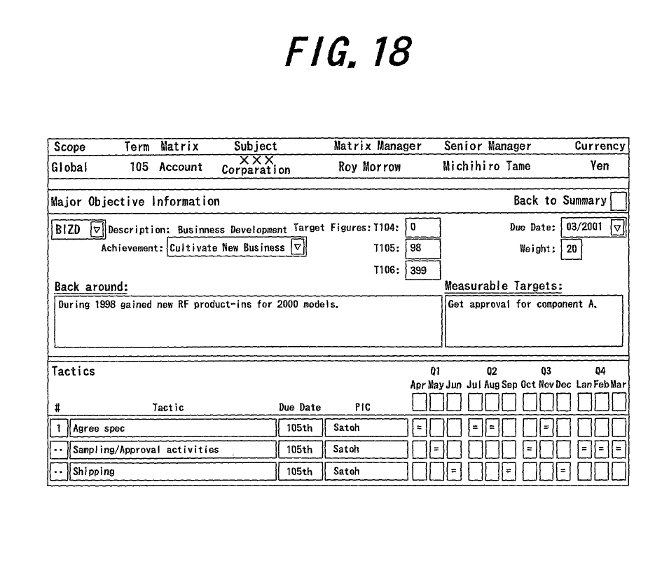

FIG. 18 is a screen interface for displaying the target and actual performance in the form of a table as a format defined action plans in regards to the certain critical target (i.e. tactics and its deadlines) and managing them. FIG. 18 shows the critical target and tactics (i.e. action plans) corresponding to the target. Additionally, via the interface, the contents in the screen may be entered and referenced and amended. The critical target and its important data with background information corresponding it in a header of the screen may be referenced. As shown in FIG. 18, the critical target is to deal with new accounts in 105th term and to achieve the sales of 9.8 billion yen in 105th term by March 2001. While in the ‘Assessable target’ field, as shown FIG. 18, comments, such as ‘getting acceptance product A’, may be described, for preference, numerical target such as share, quantity of sales, money of sales may be described. In the ‘tactics’ field, all of associated measures and its deadlines and persons in charge may be indicated. Thus, using this interface, action plans which are delayed from the dead lines and its responsible person may sharply and easily be distinguished from others.

In order to express plans status, codes (e.g. ‘=’ means on schedule, ‘−’ means amended schedule, ‘x’ means the plan has been canceled etc.) may be introduced and used them. In order to express plans progress status, progress management codes which (such as ‘A’ means as planned, ‘B’ means falling behind the schedule but achievable plans within current term, ‘C’ means falling behind the schedule and difficult to achieve within current term, ‘D’ means loss of project of the account, ‘G’ means given up ourselves and ‘Z’ means completed) may be introduced and used them. These codes can be used to easily comprehend the plan status or progress status. The plans and the performance can be sorted by key of these codes, thus, problem or good points in sales can be easily recognized, so the managers and some staffs can utilize this displayed codes and information for business management.

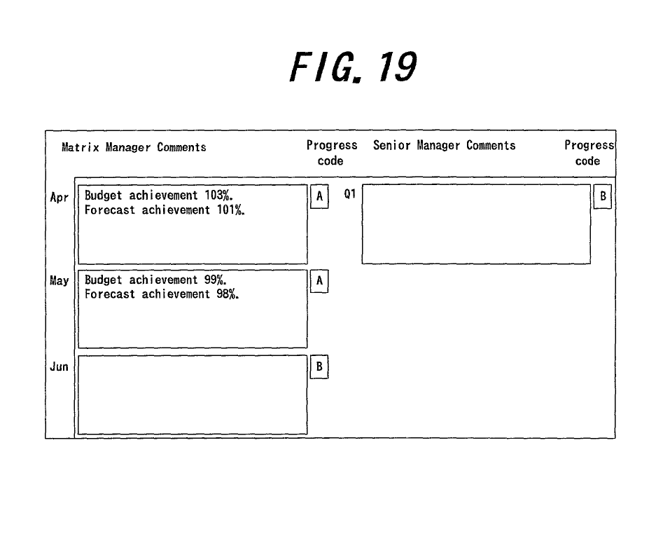

FIG. 19 is a screen interface for displaying and managing the monthly progress management comments by matrix manager. As shown in FIG. 19, the present system may prompt the matrix manager to briefly input latest repots every month in regards to the critical target and display them inputted. This latest reports comprise brief circumstances with monthly revision of progress status. Also, the present system may prompt the matrix manager to input revision of progress status and prompt senior manager to check all critical target according to predetermined period such as quarter term and prompt him to input a comment in regards to over all. It is noted that the present system may be prompt each sales reps to input the progress management comments for actual sales activities.

Such a communication is key of success about target management. Additionally, the present system allows whom it may concern to reference the particular critical target or its progress status. If the staff has interesting news involved with this target, he may freely input it in the ‘project comments’ field. The system may allows to automatically send this comments to persons concerned via e-mail. Additionally, when the persons concerned access the system via a terminal, the comments may be displayed on the screen of the terminal. Also, the comments may be attached the critical target and it may be stored in the database. Herefrom, anyone concerned can easily go back to any part of the communication and furthermore it is assured that all progression is not spoiled. If progress status has any problems, the matrix manager or sales reps may enter support request comments described the problems. The principle of this comments is basically identical with the same of project comments. Thus, the entered comments may be automatically send to persons concerned via e-mail, when persons concerned access the present system, the comment may be displayed on the screen of the terminal which is accessed. Alternatively, the comments may be attached the critical target and it may be stored in the database. Person received the comments may respond the request by whether sending an answer to the originator via e-mail or accessing the system directly to input the answer.

Each of sales reps likewise the matrix manager may set the critical target that is the initial target. Each of the target of each of sales reps must be in harmony with the target of the matrix manager. As well, The critical target of the matrix manager is basically identical with another critical target of the individual sales reps.

Estimated value of sales in next term is given by the following equation.

(Estimated value of sales in next term)=(sales budget)+(amount of increase by offensive target)−(amount of decrease by defensive target)

The offensive target means an aggressive sales goal in regards to expansion of a new market or increasing share of the existing market. On the other hand, the defensive target means a sales goal on the defensive so that continuation business can not be deprived by competitors. Almost offensive target of the sales goal in current term is little or nothing. Net increase of business is given based on value of the initial target. In this case, hit ratio ca be introduced and the different hit ratio can be applied in between the offensive and the defensive target. Experience has shown that the total value of the offensive target increases by approximately 30%. On the other hand, likewise, it is found that in fact the total value of the defensive target decreases approximately 20%. Thus, as the above equation, according to subtracting the decreasing from the increase, it can be comprehended in like realistic numeric value that the net increase of business or total sales undergo a change in what manner.

The hit ratio may be set depend on the progress status (i.e. the progress codes) of the each targets. For example, if the progress code is A, the hit ratio is set 50%;

if the progress code is B, the hit ratio is set 20%;

if the progress code is C,D or G, the hit ratio is set 0%;

if the progress code is Z, the hit ratio is set 100%. In this way, the estimated value of sales can be elicited in more realistic value.

The each of the initial target may be rated by information of ranks expressing priority or severity. For instance, they can be set as ‘rank A: top priority’, ‘rank B: important matter’, ‘rank C: target without numerical target (i.e. plan have no directory relevance to business growth)’. The each of the targets ca be sorted based of the given ranks. Thus, the manager or the sales reps can comprehend the problems on business.

It will be apparent to those skilled in the art that various modifications and variations can be made in the multi-dimensional management system and method of the present invention without departing from the spirit or scope of the invention. Thus, it is intended that the present invention cover the modifications and variations of this invention provided they come within the scope of the appended claims and their equivalents.

What is claimed is:

1. A method for managing an objectives-based business plan, the method comprising the steps of:
(a) defining major objectives according to one or more parameters;
(b) storing said major objectives in a first database;
(c) defining minor objectives based on the major objectives, wherein said minor objectives are defined according to one or more parameters.
(d) storing said minor objectives in a second database; and
(e) managing said major objectives and said minor objectives.

2. The method of claim 1, wherein the step of defining one or more major objectives includes the step of assigning each major objective to a manager.

3. The method of claim 1, wherein said major objectives include a goal and a plan for achieving said goal.

4. The method of claim 1, wherein said parameters include a product, a territory, an application, and an account.

5. The method of claim 1, wherein the step of defining minor objectives based on the major objectives includes defining minor objectives based on one major objective.

6. The method of claim 5, wherein the step of defining minor objectives based on one major objective includes the steps of assigning each major objective to a manager and assigning each related minor objective to at least one member of the manager's team.

7. The method of claim 1, wherein the step of managing said major objectives and said minor objectives includes tracking the major objectives and minor objectives.

8. The method of claim 1, wherein the step of managing said major objectives and said minor objectives includes the steps of having one or more managers implement said major objectives and having one or more members of the manager's team implement said minor objectives.

9. A method for managing an objectives-based business plan, the method comprising the steps of:
(a) defining major objectives according to one or more parameters;
(b) defining minor objectives based on the major objectives, wherein said minor objectives are defined according to one or more parameters;
(c) implementing said major objectives and said minor objectives, wherein each major objective is implemented by at least one manager and wherein said related minor objectives are implemented by at least one member of the at least one manager's team;
(d) managing said major objectives and said minor objectives; and
(e) evaluating the at least one manager's performance in achieving said major objectives and evaluating the team members' performance in achieving the related minor objectives.

10. The method of claim 9, wherein the step of defining major objectives according to one or more parameters includes the steps of having each manager responsible for a parameter propose a major objective and having senior management approve said major objectives.

11. The method of claim 9, wherein said major objectives include a goal and a plan for achieving said goal.

12. The method of claim 9, wherein the step of defining minor objectives based on the major objectives includes the steps of:
(a) having the at least one manager propose minor objectives for the at least one member of the manager's team;
(b) having the at least one member of the manager's team propose minor objectives; and
(c) finalizing said minor objectives;

13. The method of claim 9, wherein said parameters include a product, a territory, an application, and an account.

14. The method of claim 9, wherein the step of managing said major objectives and said minor objectives includes tracking the major objectives and minor objectives.

15. A system for managing an objectives-based business plan, the system comprising:
(a) a first database for storing major objectives based on one or more parameters;
(b) a second database for storing minor objectives based on the major objectives, wherein said minor objectives are defined according to one or more parameters; and
(c) an information processing component for manipulating content of said first database and said second database.

16. The system of claim 15, wherein said major objectives include a goal and a plan for achieving said goal.

17. The system of claim 15, wherein said parameters include a product, a territory, an application, and an account.

18. The system of claim 15, wherein said information processing component includes communication tools for exchanging information regarding said major objectives and said minor objectives.

19. The system of claim 18, wherein said communication tools include an integrated e-mail tool that stores a message regarding a major objective or minor objective in the corresponding database.

20. The system of claim 15, wherein said information processing component includes data management tools for tracking, measuring, and displaying content of said first database and said second database.

21. The system of claim 20, wherein said data management tools includes a management system for tracking administrative functions.

22. The system of claim 20, wherein said data management tools include a financial indicator system for tracking the status of one or more sales indicators.

23. The system of claim 20, wherein said data management tools include an inquiry system for tracking the status of one or more orders.

24. A system for managing corporate objectives in multi-dimensional matrix, the system comprising:
means for storing a initial target including at least a sales goal and an action plan in a database in the form of multi-dimensional matrix consisting of four axes of a product, a territory, an application and an account;
means for prompting to input a actual performance including actual money or volume of sales performance and actual sales activities corresponding to said initial target by using a local and/or remote terminal;
means for receiving said actual performance;
means for storing said received actual performance in the database;
means for managing an achievement of the target by reading the said initial target and said actual performance and selecting any one or more from said four axes and displaying said initial target and/or said actual performance along to the selected axis or axes on the local and/or remote terminal.

25. The system according to claim 24, the system comprising:
means for managing a sales achievement by comparing said initial target with said actual performance corresponding to said initial target and based on this comparison sorting said initial target and/or said actual performance and displaying them on the local and/or remote terminal.

26. The system according to claim 25, the system comprising;
said means for managing a sales achievement further comprises;
means for changing a display style of said initial target and/or said actual performance based on said comparison and displaying them on the local or remote terminal.

27. The system according to claim 24, wherein that:
said actual performance further comprises a progress code, expressing progress status, including at least ‘on the schedule’, ‘behind the schedule’ and ‘completed’, and the system comprising:
means for managing progress by displaying the said actual performance based on the said progress code and/or any one of said four axes on the local and/or remote terminal.

28. The system according to claim 24, the system comprising:
means for altering said initial target based on said actual performance and/or business trend.

29. The system according to claim 27, the system comprising:
means for altering said initial target based on said actual performance and/or business trend.

30. A method for managing corporate objectives in multi-dimensional matrix, comprising the steps of:
storing a initial target including at least a sales goal and an action plan in a database in the form of multi-dimensional matrix consisting of four axes of a product, a territory, an application and an account;
prompting to input a actual performance including actual money or volume of sales performance and actual sales activities corresponding to said initial target for a predetermined term till predetermined due date by using a local and/or remote terminal;
receiving said actual performance;
storing said received actual performance in the database;
managing an achievement of the target by reading the said initial target and said actual performance and selecting any one or more from said four axes and displaying said initial target and/or said actual performance along to the selected axis or axes on the local and/or remote terminal.

31. The method according to claim 30, the method comprising:
managing a sales achievement by comparing said initial target with said actual performance corresponding to said initial target and based on this comparison sorting said initial target and/or said actual performance and displaying them on the local or remote terminal.

32. The method according to claim 31, the method comprising;
the step of managing a sales achievement further comprises;
changing a display style of said initial target and/or said actual performance based on said comparison and displaying them on the local and/or remote terminal.

33. The method according to claim 30, wherein that:
said actual performance further comprises a progress code, expressing progress status, including at least ‘on the schedule’, ‘behind the schedule’ and ‘completed’, and the method comprising:
managing progress by displaying the said actual performance based on the said progress code and/or any one of said four axes on the local and/or remote terminal.

34. The method according to claim 30, the method comprising:
altering said initial target based on said actual performance and/or business trend.

35. The method according to claim 33, the method comprising:
altering said initial target based on said actual performance and/or business trend.
